(19) United States
(12) Patent Application Publication
(10) Pub. No.: US 2003/0137147 A1
(43) Pub. Date: Jul. 24, 2003

(54) Decoupling hose for a motor vehicle engine exhaust pipe

(76) Inventors: Claire Girot, Barbizon (FR); Jean-Pierre Ciolczyk, Montargis (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/345,515

(22) Filed: Jan. 16, 2003

(30) Foreign Application Priority Data
Jan. 22, 2002 (FR) 0200738

(51) Int. Cl. F16L 27/10

(52) U.S. Cl. 285/47; 285/301; 285/226

(57) ABSTRACT

A decoupling hose for mounting in an exhaust pipe of a motor vehicle engine, the hose comprising in particular an inner mechanical portion for guiding the flow of exhaust gas through the hose, a sealing portion forming an outer casing that is leakproof relative to exhaust gas, an intermediate portion providing thermal insulation, and means for connecting the ends of the inner and outer portions of the hose to the exhaust pipe, wherein the inner mechanical portion of the hose is constituted by a metal tubular part in the form of sheet metal joined by dual folded seam connections that are very loose.

The invention relates to a decoupling hose mounted in the exhaust pipe of a motor vehicle engine.

### BACKGROUND OF THE INVENTION

In general, the exhaust pipe of a motor vehicle engine is mounted to the outlet from the engine exhaust manifold. The exhaust pipe generally comprises one or more “pots” (catalytic converter, expander, muffler) constituting masses disposed along a pipe, itself made up of one or more rigidly interconnected portions. The assembly is suspended from the vehicle body via moderately flexible connections that are formed by suspension straps or studs that are generally based on elastomer, and that need to be capable of accommodating movements of the engine associated with vertical accelerations, with sudden changes of speed, with thermal expansion, with assembly tolerances, . . . .

That is why an exhaust pipe usually includes a flexible tubular coupling referred to as a “decoupling hose” which prevents the exhaust pipe being damaged or destroyed by the various effects mentioned above. The hose provides the flexibility needed for decoupling engine vibration from the exhaust pipe and from the vehicle body, and it improves comfort in the vehicle cabin.

In general, the hose must be capable of continuously withstanding the flow of hot gas whose temperature can reach or even exceed 900° C., and it must also be capable of withstanding the outdoor conditions to which the exhaust pipe is subjected. However, the hose must not interfere with the operation of the various elements making up the exhaust pipe, and in particular, with gasoline engines it must prevent any air penetrating into the catalytic converter.

Document FR-A-2 796 416 describes a decoupling hose comprising in particular an internal mechanical portion for guiding the flow of exhaust gases through the hose, a sealing portion forming an outer casing that is continuous, closed, and leakproof, and an intermediate thermal insulation or “lagging” portion interposed between the mechanical and sealing portions of the hose. The outer casing forming the sealing portion is subdivided into a flexible central zone which is made of a material that withstands high temperatures, and two rigid end zones in the form of metal caps around which cooling fins can be fitted.

Hoses are also known that are constituted by tubes of stainless steel sheet that are 0.3 millimeters (mm) to 0.5 mm thick, the sheet being corrugated to form internal sheathing, and being covered with external braiding or knitting. Nevertheless, those hoses are stiff and present vibratory modes that are well-marked and noisy. In addition, they cannot withstand any tension, any twisting, or any departure beyond acceptable levels of deformation in bending, in shear, or in compression.

### OBJECTS AND SUMMARY OF THE INVENTION

An object of the invention is to take account more specifically of the dynamic stresses exerted on a decoupling hose in order to obtain total decoupling so that the hose presents dynamic stiffness that is low and substantially constant over the entire range of frequencies and mechanical stresses to which it is subjected.

To this end, the invention provides a decoupling hose for mounting in an exhaust pipe of a motor vehicle engine, the hose comprising in particular an inner mechanical portion for guiding the flow of exhaust gas through the hose, a sealing portion forming an outer casing that is leakproof relative to exhaust gas, an intermediate portion providing thermal insulation, and means for connecting the ends of the inner and outer portions of the hose to the exhaust pipe, wherein the inner mechanical portion of the hose is constituted by a metal tubular part in the form of sheet metal joined by dual folded seam connections that are very loose.

According to another characteristic of the hose of the invention, at least one end of the metal tube is flared to be connected directly to a segment of the exhaust pipe.

A hose of the invention also presents the advantage of channeling the flow of exhaust gas well, of satisfying those dynamic stresses that result from the high speed of said gas flow, and of being capable of being subjected to mechanical deformation in all directions.

With such a decoupling hose, the exhaust pipe downstream from the hose is subjected to much less stress and its lifetime is longer.

### BRIEF DESCRIPTION OF THE DRAWINGS

Other advantages, characteristics, and details of the invention appear from the additional description below given with reference to the accompanying drawings, given purely by way of example and in which:

FIG. 1 is a longitudinal section view through a decoupling hose of the invention presented as two half-views, one on the left and the other on the right to illustrate two embodiments;

FIG. 2 is a detail view indicated by arrow II in FIG. 1; and

FIG. 3 is a graph showing the results of decoupling tests that have been performed respectively on a hose of the invention and on a prior art hose.

### MORE DETAILED DESCRIPTION

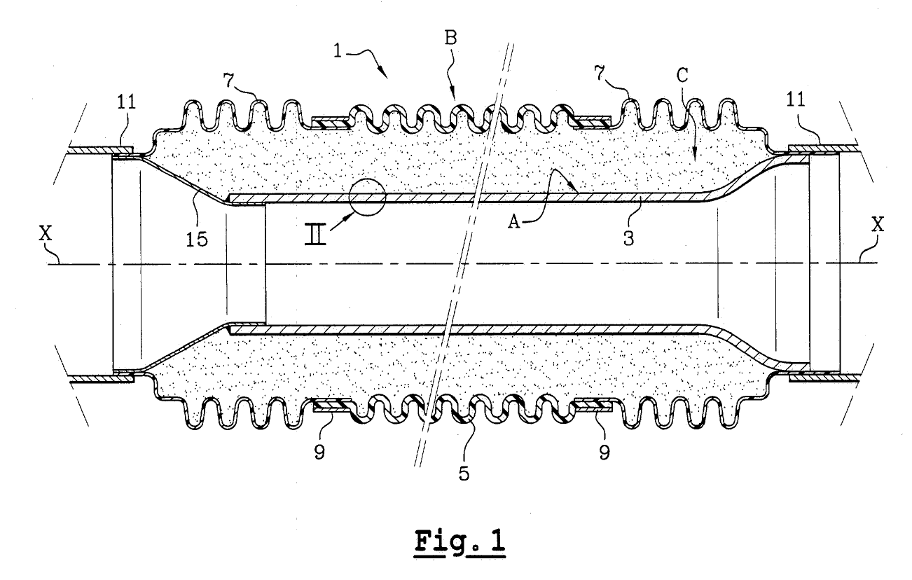

The decoupling hose 1 of the invention as shown in FIG. 1 presents a tubular structure about an axis X-X and it comprises in particular at least one inner mechanical portion A for guiding the flow of exhaust gas which may reach speeds of the order of 100 meters per second (m/s), an outer sealing portion B for providing sealing relative to the exhaust gas, and an intermediate portion C serving at least to provide thermal insulation for the outer portion B.

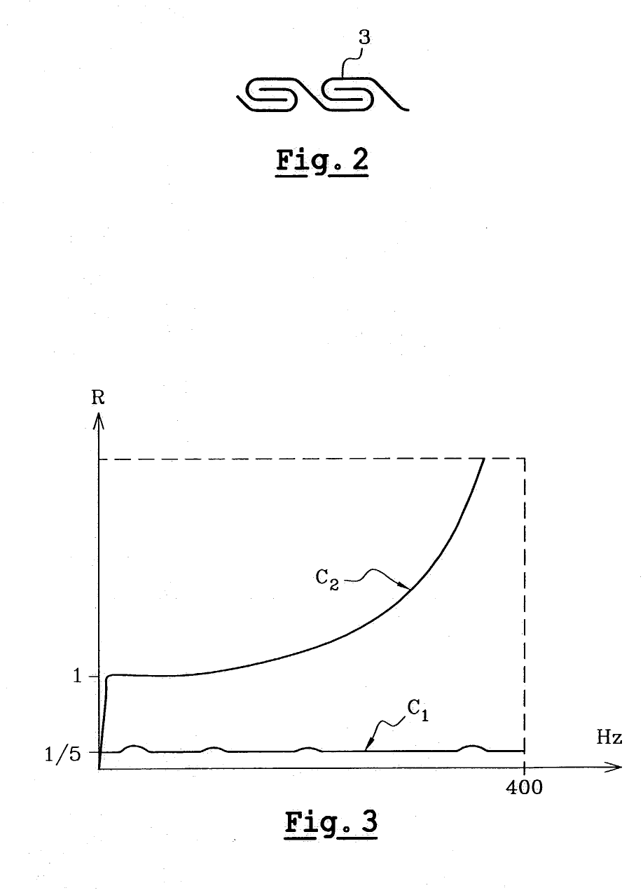

The inner tubular portion A of the decoupling hose 1 is a tubular metal part in the form of a metal sheet with a folded seam connection or joint 3 implemented as a dual folded joint that is very loose, of the type shown in FIG. 2, rather than as a single folded joint, and this is for reasons that are explained below.

The sealing portion B of the decoupling hose 1 forms a gastight outer casing which comprises a flexible central zone and two rigid end zones. By way of example, the central zone 5 is constituted by a bellows of material that can withstand high temperatures, such as silicone, and each of the end zones is constituted by a respective corrugated tube 7 which also constitutes cooling means by increasing the heat exchange area between the hose 1 and the outside. In general, the wall thickness of such corrugated tubes 7 is quite small, being about 0.3 mm to 0.6 mm, for example.

To reduce the number of component parts making up the hose, each corrugated tube 7 presents the changes of diameter needed to enable it to be connected firstly to the central zone 5 of the leakproof casing and secondly to the exhaust pipe. Each corrugated tube 7 is connected to the central zone 5 by means of a clamping collar 9, for example, whereas it is connected to a segment of the exhaust pipe 11 by welding, for example.

The lagging portion C is constituted by an annular mat 13 of fiber material, for example, which material penetrates into the inside of the two corrugated tubes 7 so as to extend over substantially the entire length of the hose. By using a dual folded joint 3 it is possible to avoid subjecting the insulating mat 13 to wear, given that a single folded joint would present this drawback because it would tend to pinch the mat.

In a first embodiment shown in the left-hand half-view of FIG. 1, the folded joint tube 3 is extended at each end by a flared connecting metal endpiece 15 for connection with the segments of exhaust pipe 11, connection being provided by welding, for example.

In a second embodiment, shown in the right-hand half-view of FIG. 1, the folded joint tube 3 itself flares at each end to be connected directly to the exhaust pipe segments 11.

In a variant, the two embodiments described above can be combined, with one end of the folded joint tube 3 being connected to the exhaust pipe via a flared endpiece, while its other end is itself flared for connecting directly to the exhaust pipe.

Decoupling tests have been performed on a test bench by subjecting the hose 5 of the invention to mechanical stresses in the form of small vibrations having an amplitude of about 0.1 mm and at frequencies lying in the range 0 to 400 hertz (Hz). Curve C₁ shown in FIG. 3 shows that the dynamic stiffness R of the hose 5 remains substantially constant, whereas curve C₂ for a hose of internal structure that is rigid increases with frequency. These curves show that the decoupling obtained with a hose of the invention is almost complete, which is the object sought by the invention.

In general, the dimensions of the hose and its component parts are not frozen and they can be varied depending on the amount of space available for the hose. Nevertheless, the inside diameter of the folded joint tube 3 should not be too small in order to minimize head losses, and it should not be too great so as to ensure that the thickness of the insulating mat 13 is sufficient for limiting the transmission of heat to the leakproof casing 5 and 7.

What is claimed is:

1. A decoupling hose for mounting in an exhaust pipe of a motor vehicle engine, the hose comprising in particular an inner mechanical portion for guiding the flow of exhaust gas through the hose, a sealing portion forming an outer casing that is leakproof relative to exhaust gas, an intermediate portion providing thermal insulation, and means for connecting the ends of the inner and outer portions of the hose to the exhaust pipe, wherein the inner mechanical portion of the hose is constituted by a metal tubular part in the form of sheet metal joined by dual folded seam connections that are very loose.

2. A decoupling hose according to claim 1, wherein at least one end of the metal tube is flared to be connected directly to a segment of the exhaust pipe.

3. A decoupling hose according to claim 1, wherein both ends of the metal tube are connected to respective segments of the exhaust pipe by means of connection endpieces.

4. A decoupling hose according to claim 1, wherein the intermediate portion forming the thermal insulating is constituted by a fiber mat.
